(19) United States
(12) Patent Application Publication
(10) Pub. No.: US 2011/0122334 A1
(43) Pub. Date: May 26, 2011

(54) LIQUID CRYSTAL DISPLAY, METHOD FOR ASSEMBLING SAME, AND DISPLAY APPARATUS

(75) Inventor: CHIH-SHUN TANG, Miao-Li County (TW)

(73) Assignee: CHIMEI INNOLUX CORPORATION, Miao-Li County (TW)

(21) Appl. No.: 12/948,772

(22) Filed: Nov. 18, 2010

(30) Foreign Application Priority Data
Nov. 20, 2009 (TW) 98139424

(51) Int. Cl. G02F 1/1333

(52) U.S. Cl. 349/58

(57) ABSTRACT

An exemplary liquid crystal display includes a liquid crystal panel, a backlight module for illuminating the liquid crystal panel, and a flexible printed circuit board attached to the liquid crystal panel. The backlight module includes a frame for receiving the liquid crystal panel, and the flexible printed circuit board includes electronic components. The frame includes a groove defined at a sidewall thereof. The flexible printed circuit board covers the sidewall of the frame whereby the electronic components are received in the at least one groove. Glue material is contained in the groove and surrounds the electronic components, such that the flexible printed circuit board is attached onto the frame. A method for assembling a liquid crystal display and a display apparatus are also provided.

### BACKGROUND

1. Technical Field

The present disclosure relates to display apparatuses such as liquid crystal displays (LCDs); and particularly to an LCD having a flexible printed circuit board (FPCB) with electronic components received in a frame of a backlight module, and a method for assembling the LCD.

2. Description of Related Art

LCDs have the advantages of portability, low power consumption, and low radiation, and thus are widely used in various portable information technology products, such as notebooks, personal digital assistants, video cameras, and the like.

A commonly used LCD generally includes a liquid crystal panel and a backlight module. The backlight module is located under the liquid crystal panel, and is adapted for illuminating the liquid crystal panel. In operation, the liquid crystal panel receives driving signals (e.g., driving voltages) from a driving circuit. The liquid crystal panel controls light transmission therethrough according to the driving signals, so as to display a corresponding image.

The driving circuit is disposed on an FPCB folded in a specific shape, which includes a fixed end portion, an opposite free end portion, and a middle portion. The fixed end portion is attached onto an edge of the liquid crystal panel, the middle portion lies along side surfaces of the liquid crystal panel and the backlight module, and the free end portion is arranged below a bottom surface of the backlight module. Moreover, electronic components constituting the driving circuit are mounted on the free end portion of the FPCB, and the electronic components are electrically connected to the liquid crystal panel through metal wires within the FPCB.

However, in the described LCD, because the driving circuit is disposed at the free end portion of the FPCB, the electronic components of the driving circuit are susceptible to damage when the LCD sustains shock, for example, when the LCD falls to the ground or is bumped. Thus, the reliability of the LCD is affected.

What is needed, therefore, is an LCD that can overcome the described limitations, and a method for assembling the LCD.

### BRIEF DESCRIPTION OF THE DRAWINGS

The components in the drawings are not necessarily drawn to scale, the emphasis instead placed upon clearly illustrating the principles of at least one embodiment. In the drawings, like reference numerals designate corresponding parts throughout the various views.

FIG. 1 is an exploded, isometric view of an LCD according to an embodiment of the present disclosure.

FIG. 2 is an isometric view of the LCD of FIG. 1, showing the LCD inverted and partly assembled.

FIG. 3 is similar to FIG. 2, but showing the LCD fully assembled.

FIG. 4 is a cross-section of the LCD of FIG. 3, taken along line IV-IV.

FIG. 5 is a flowchart of a method for assembling an LCD according to an embodiment of the present disclosure.

### DETAILED DESCRIPTION

Reference will now be made to the drawings to describe certain exemplary embodiments of the present disclosure in detail.

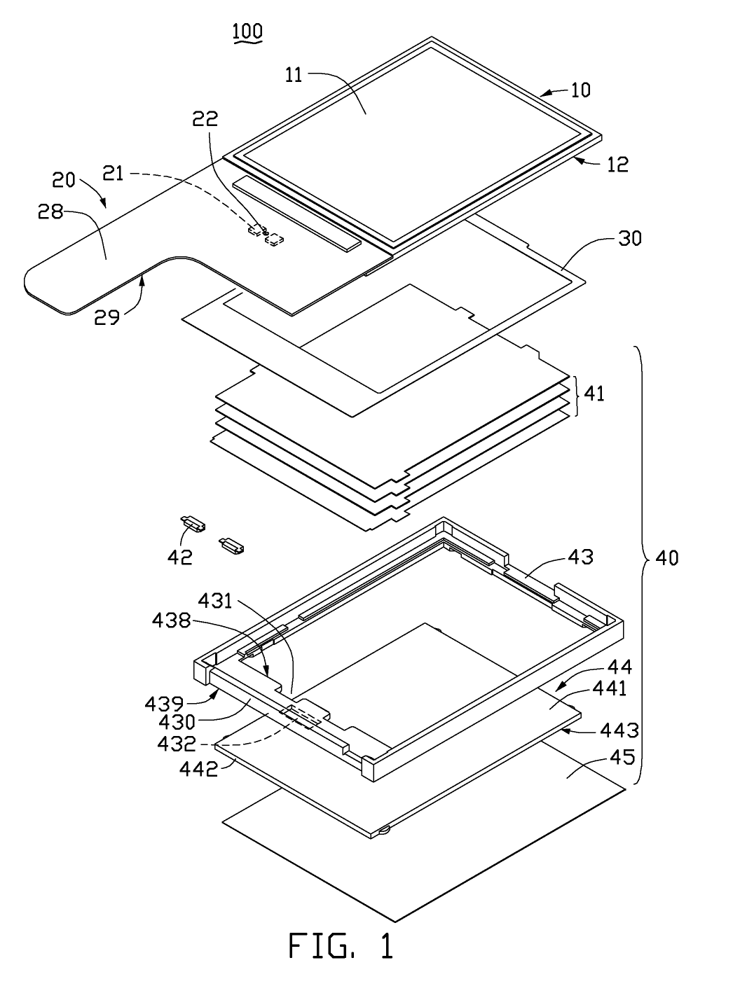

FIG. 1 is an exploded, isometric view of an LCD 100 according to an embodiment of the present disclosure. The LCD 100 includes a liquid crystal panel 10, an FPCB 20, a light shield film 30, and a backlight module 40. The liquid crystal panel 10 includes a top display surface 11 and a bottom surface 12. The backlight module 40 is adapted for illuminating the liquid crystal panel 11, and is located under the bottom surface 12 of the liquid crystal panel 10. The light shield film 30 is adapted to prevent light leakage, for example, by absorbing light beams emitted in undesired directions, and is located between the backlight module 40 and the liquid crystal panel 10.

The FPCB 20 may be attached to the liquid crystal panel 10. The FPCB 20 may include a fixed end portion attached onto an edge of the display surface 11 of the liquid crystal panel 10, and the remainder of the FPCB 20 may be folded along side surfaces of the liquid crystal panel 10 and the backlight module 40, and further laid onto a bottom surface of the backlight module 40.

In the illustrated embodiment, the FPCB 20 includes an upper surface 28 and a bottom surface 29 as viewed when the FPCB 20 is unfolded. Upon being folded, the lower surface 29 lies beside and contacts the side surface of the liquid crystal panel 10 as well as the side surface of the backlight module 40, and further covers the bottom surface of the backlight module 40. Moreover, a plurality of electronic components 21 is mounted onto the lower surface 29 of the FPCB 20. To simplify the drawings, only two electronic components 21 are schematically illustrated in FIG. 1. The electronic components 21 may for example be integrated circuit (IC) chips or discrete components such as capacitors and resistors. The electronic components 21, together with conductive wires within the FPCB 20, cooperatively constitute a driving circuit providing driving signals to drive the liquid crystal panel 10 to display images. Moreover, at least one through hole 22 passing from the upper surface 28 to the bottom surface 29 of the FPCB 20 is formed about the electronic components 21. In the illustrated embodiment, there is one through hole 22, which is located between the electronic components 21.

The backlight module 40 includes an optical film set 41, a plurality of light sources 42, a frame 43, a light guide plate 44, and a reflector 45. The optical film set 41 may include several optical films such as a brightness enhancement film, an upper diffuser, and a lower diffuser. The light sources 42 may be light emitting diodes (LEDs). The frame 43 may be a rectangular plastic frame having four sidewalls 430. The four sidewalls 430 are end-to-end connected, and cooperatively form an upper accommodating space for receiving the optical film set 41, the light shield film 30, and the liquid crystal panel 11 in that order from bottom to top, and a lower accommodating space for receiving the light guide plate 44 and the reflector 45. One of the sidewalls 430 of the frame 43 has a greater width, and has a plurality of recesses 431 defined at an inner side surface 438 thereof. The light sources 42 can be received within the recesses 431.

The light guide plate 44 includes a light incident surface 442, a bottom surface 443 adjoining the light incident surface 442, and a top light emitting surface 441. When the light guide plate 44 is received in the lower accommodating space defined by the frame 43, the light incident surface 442 faces the inner side surface 438 of the wider sidewall 430. Thereby, light beams emitted from the light sources 42 can be transmitted into the light guide plate 44 via the light incident surface 442. The reflector 45 may be located adjacent to the bottom surface 443 of the light guide plate 44.

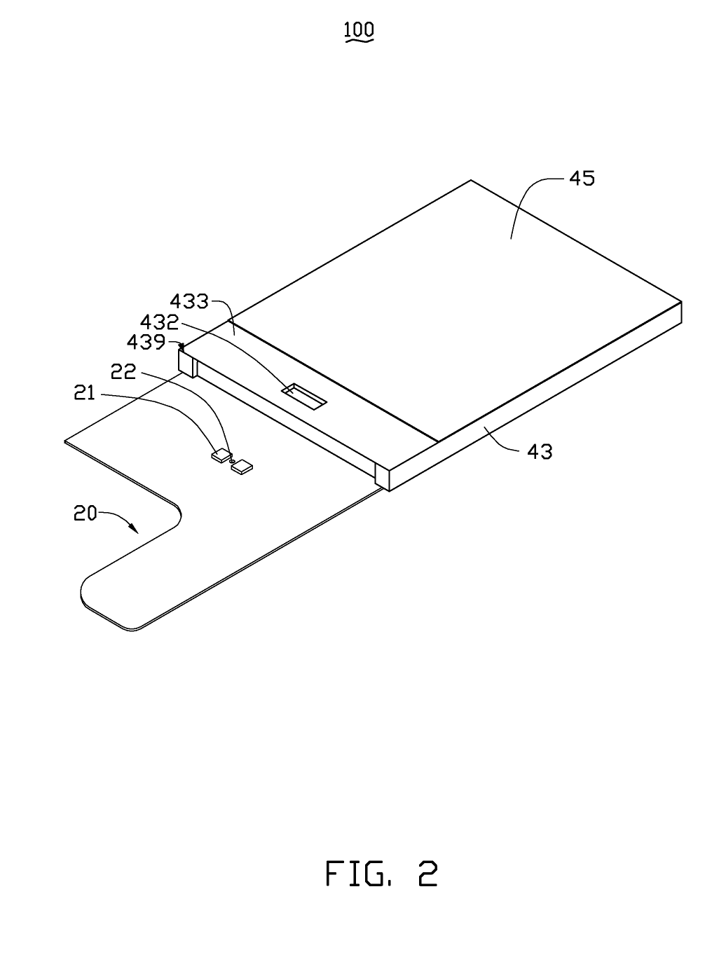

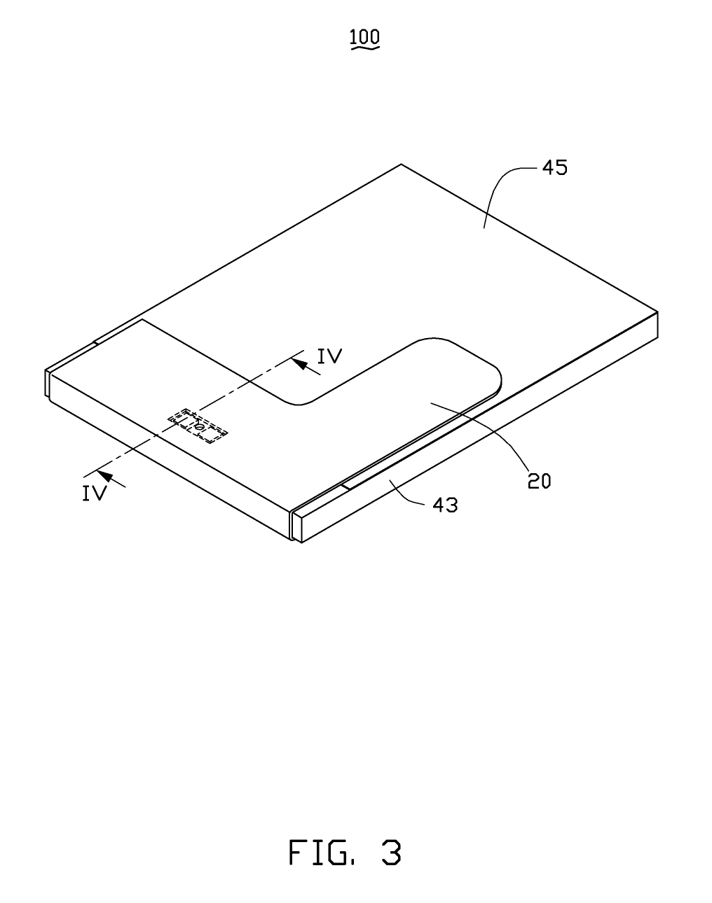

Moreover, referring also to FIG. 2, at least one groove 432 is defined at a bottom surface 439 of the wider sidewall 430. In the illustrated embodiment, there is one groove 432. The groove 432 is positioned corresponding to the electronic components 21, and is configured to receive the electronic components 21 when the FPCB 20 is folded to lie on the corresponding surfaces of the backlight module 40, as shown in FIG. 3.

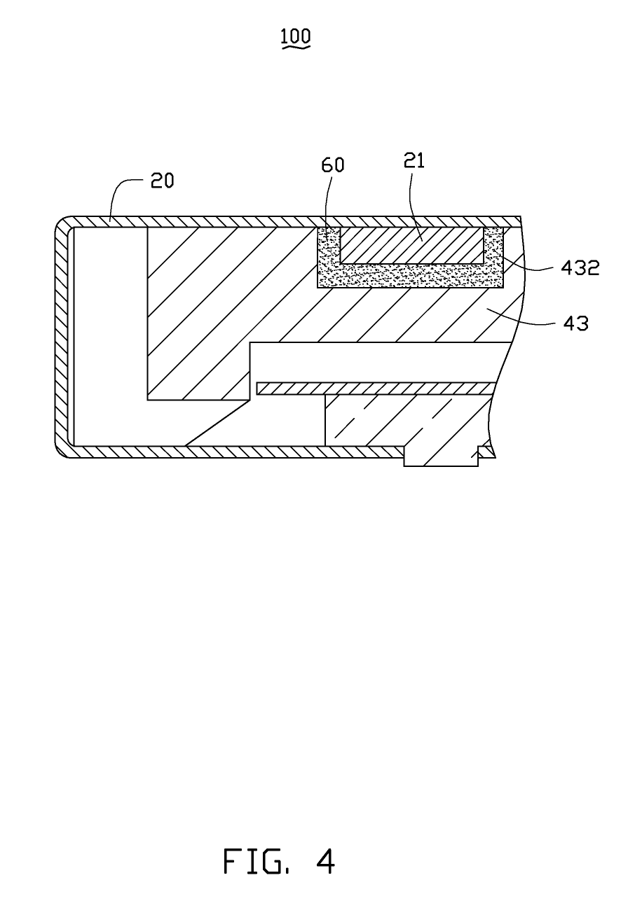

Additionally, referring also to FIG. 4, glue material (adhesive) 60 can be disposed inside the groove 432. The glue material 60 may surround the electronic components 21 mounted on the FPCB 20 when the electronic components 21 are received in the groove 432, so as to enable the FPCB 20 to adhere to the backlight module 40. In particular, the glue material 60 can initially be in form of liquid glue injected into the at least one groove 432 via the through hole 22 during assembly of the LCD 100, and solidified thereafter. The liquid glue can be made of a moisture-proof insulating material for circuit boards, for example, the product marketed under the trademark Tuffy®, which has low contamination and low moisture penetration when hardened, and with speedy solidification at room temperature. In one particular embodiment, the liquid glue can be made of an acrylic resin such as Tuffy® TF-1141, which is a registered trademark of Hitachi Chemical Co., Ltd.). After solidification, gaps between the electronic components 21 and inner surfaces of the groove 432 are filled with the glue material 60. The electronic components 21 are thus sealed by the glue material 60, which isolates and protects the electronic components 21 from corrosion or contamination by external agents such as vapor.

In the LCD 100, as described, the frame 43 of the backlight module 40 defines the groove 432 for receiving the electronic components 21 mounted on the FPCB 20, and the electronic components 21 together with the FPCB 20 can further be fixed to the frame 43 by the glue material 60 inside the groove 432. With this configuration, the electronic components 21 can be protected from damage when the LCD 100 sustains shock. Moreover, the glue material 60 encapsulating the electronic components 21 can additionally protect the electronic components 21 even from major shock. Therefore, the reliability of the LCD 100 is further improved.

In an alternative embodiment, a length of the FPCB 20 can be less than that illustrated in FIG. 1, and the groove 432 can alternatively be provided at the outer lateral side surface of the wider sidewall 430. As such, when the FPCB 20 is folded, the FPCB 20 lies on the outer lateral side surface of the wider sidewall 430 and the electronic components 21 are received in the groove 432. This can be achieved without the FPCB 20 covering the bottom surface 439 of the wider sidewall 430.

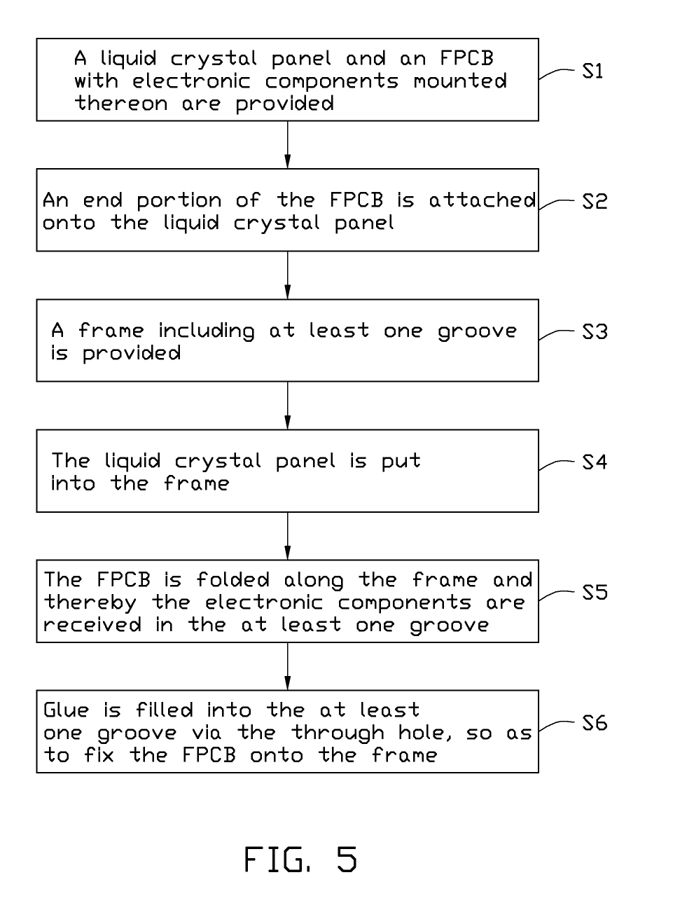

Furthermore, the present disclosure also provides a method for assembling an LCD, for example, the above-described LCD 100. Referring to FIG. 5, the method may include steps as follows. In step S1, a liquid crystal panel and an FPCB with electronic components mounted thereon are provided. In step S2, an end portion of the FPCB is attached onto the liquid crystal panel. In step S3, a frame including at least one groove is provided. In step S4, the liquid crystal panel is put into the frame. In step S5, the FPCB is folded along the frame and thereby the electronic components are received in the at least one groove. In step S6, glue is filled into the at least one groove via the through hole, so as to fix the FPCB onto the frame. These steps are described in more detail below, with reference to the LCD 100 by way of example.

In step S1, a liquid crystal panel 10 and an FPCB 20 with a plurality of electronic components 21 mounted thereon are provided. The FPCB 20 may include the electronic components 21 mounted on a bottom surface 29 thereof. Moreover, a through hole 22 is formed in the FPCB 20 among the electronic components 21.

In step S2, an end portion of the FPCB 20 is attached to the liquid crystal panel 10. In detail, a fixed end portion of the FPCB 20 can be soldered onto an edge of the liquid crystal panel 10, whereby the fixed end portion of the FPCB 20 is electrically connected to the liquid crystal panel 10 via solder material.

In step S3, a frame 43 including a groove 432 is provided. The frame 43 may include a plurality of sidewalls 430 cooperatively defining an upper accommodating space and a lower accommodating space. The groove 432 can for example be formed at a bottom surface 439 of one sidewall 430 of the frame 43. In this embodiment, the sidewall 430 is a wider one of the sidewalls 430. The wider sidewall 430 further defines a plurality of recesses 431 at an inner surface 438 thereof.

In step S4, the liquid crystal panel 10 is put into the frame 43. In detail, all of an optical film set 41, a light shield film 30, and the liquid crystal panel 10 can be put into the upper accommodating space of the frame 43 in that order from bottom to top, and further a light guide plate 44 and a reflector 45 can be put into the lower accommodating space of the frame 43. Moreover, a plurality of light sources 12 can be put into the recesses 431 of the wider sidewall 430.

In step S5, the FPCB 20 is folded along the frame 43, and thereby the electronic components 21 are received in the groove 432. In detail, the FPCB 20, other than the fixed end portion thereof, can be folded along an outer lateral side surface of the wider sidewall 430 and then cover the bottom surface 439 of the wider sidewall 430, with the electronic components 21 being received in the groove 432 and the through hole 22 aligning with the groove 432.

In step S6, glue material 60 is filled into the groove 432 via the through hole 22, so as to fix the FPCB 20 onto the frame 43. The glue material 60 can be liquid glue, and the liquid glue can be injected into the groove 432 via the through hole 22. After the liquid glue is solidified, gaps between the electronic components 21 and inner surfaces of the groove 432 are fully filled with the glue material 60, and the electronic components 21 are thus sealed by the glue material 60.

It is to be further understood that even though numerous characteristics and advantages of preferred and exemplary embodiments have been set out in the foregoing description, together with details of the structures and functions of the embodiments, the disclosure is illustrative only; and that changes may be made in detail, especially in matters of shape, size and arrangement of parts within the principles of disclosure to the full extent indicated by the broad general meaning of the terms in which the appended claims are expressed.

What is claimed is:

1. A liquid crystal display, comprising:
a liquid crystal panel;
a backlight module for illuminating the liquid crystal panel, the backlight module comprising a frame receiving the liquid crystal panel, the frame comprising a sidewall, the sidewall having at least one groove defined therein; and
a flexible printed circuit board attached to the liquid crystal panel, and comprising at least one electronic component;
wherein the flexible printed circuit board covers the sidewall of the frame whereby the at least one electronic component is received in the at least one groove, and glue material is contained in the at least one groove and surrounds the at least one electronic component, such that the flexible printed circuit board is attached onto the frame.

2. The liquid crystal display of claim 1, wherein the at least one groove is defined at a bottom surface of the sidewall of the frame, and the flexible printed circuit board is folded to lie along a side surface of the sidewall and cover the bottom surface of the sidewall.

3. The liquid crystal display of claim 2, wherein the frame further comprises a plurality of recesses defined at an inner surface of the sidewall, and the recesses are configured to receive light sources.

4. The liquid crystal display of claim 3, wherein the frame further comprises a plurality of sidewalls, the sidewall and the plurality of sidewalls cooperatively define an upper accommodating space for receiving an optical film, a light shield film, and the liquid crystal panel, and a lower accommodating space for receiving a light guide plate and a reflector.

5. The liquid crystal display of claim 1, wherein the flexible printed circuit board further comprises at least one through hole defined in the vicinity of the at least one electronic component, and the at least one through hole is positioned adjacent to the at least one groove.

6. The liquid crystal display of claim 5, wherein the at least one through hole provides access for the filling of the glue material when in liquid form into the at least one groove.

7. The liquid crystal display of claim 6, wherein the at least one electronic component comprises two electronic components, and the at least one through hole is defined between the two electronic components.

8. The liquid crystal display of claim 1, wherein the at least one groove is defined at a lateral outer side surface of the sidewall of the frame, and the flexible printed circuit board is folded to lie on the lateral outer side surface of the sidewall without covering a bottom surface of the sidewall.

9. The liquid crystal display of claim 1, wherein the glue material is configured to isolate the at least one electronic component received in the at least one groove from corrosion or contamination by external agents.

10. A method for assembling a liquid crystal display device, the method comprising:
providing a liquid crystal panel and a flexible printed circuit board, the flexible printed circuit board comprising at least one electronic component mounted thereon;
attaching one end of the flexible printed circuit board onto the liquid crystal panel;
providing a frame comprising a sidewall, the sidewall having at least one groove defined therein;
putting the liquid crystal panel into the frame;
folding the flexible printed circuit board along the sidewall such that the at least one electronic component is received in the at least one groove; and
putting glue material into the at least one groove to fix the flexible printed circuit board onto the frame.

11. The method of claim 10, wherein the flexible printed circuit board further comprises at least one through hole defined in the vicinity of the at least one electronic component.

12. The method of claim 11, wherein putting glue material into the at least one groove comprises:
filling liquid glue into the at least one groove via the at least one through hole, the liquid glue filled in the at least one groove sealing the at least one electronic component; and
solidifying the liquid glue whereby the solid glue encapsulates the at least one electronic component.

13. The method of claim 12, wherein after solidifying the liquid glue, gaps between the at least one electronic component and inner surfaces of the at least one groove are fully filled with the solid glue.

14. The method of claim 10, wherein the glue material is configured to seal and isolate the at least one electronic component received in the at least one groove from corrosion or contamination by external agents.

15. The method of claim 10, wherein the at least one groove is defined at a bottom surface of the sidewall of the frame, and after folding the flexible printed circuit board along the sidewall, the flexible printed circuit board lies along a side surface of the sidewall and covers the bottom surface of the sidewall.

16. The method of claim 10, wherein the at least one groove is defined at a lateral outer side surface of the sidewall of the frame, and after folding the flexible printed circuit board along the sidewall, the flexible printed circuit board lies on the lateral outer side surface of the sidewall without covering a bottom surface of the sidewall.

17. A display apparatus, comprising:
a display panel;
a frame receiving the display panel, the frame comprising at least one groove;
a flexible printed circuit board attached to the display panel, and comprising at least one electronic component, the flexible printed circuit board being bent along the frame with the at least one electronic component received in the at least one groove; and
glue material filled in the at least one groove and sealing the at least one electronic component and attaching the flexible printed circuit board onto the frame.

18. The display apparatus of claim 17, wherein the at least one groove is defined at a bottom surface of the sidewall of the frame, and the flexible printed circuit board is bended to lie along a side surface of the sidewall and cover the bottom surface of the sidewall.

19. The display apparatus of claim 17, wherein the at least one groove is defined at a side surface of the sidewall of the frame, and the flexible printed circuit board is bended to lie on the side surface of the sidewall without covering a bottom surface of the sidewall.

20. The display apparatus of claim 17, wherein the glue material is configured to isolate the at least one electronic component received in the at least one groove from corrupting by external vapor.
